(19) United States
(12) Patent Application Publication
(10) Pub. No.: US 2012/0194555 A1
(43) Pub. Date: Aug. 2, 2012

(54) SYSTEM AND PROCESS FOR VIRTUALLY DECORATING A ROOM OR AREA

(76) Inventor: Cynthia Byrnes, Westport, CT (US)

(21) Appl. No.: 13/338,952

(22) Filed: Dec. 28, 2011

Related U.S. Application Data
(60) Provisional application No. 61/427,514, filed on Dec. 28, 2010.

(51) Int. Cl. G09G 5/00

(52) U.S. Cl. 345/634

(57) ABSTRACT

A computer system and method for providing virtual decoration of an area to be decorated with artwork. The method and system adapted and configured to receive a digital image of an area to be decorated and provide a digital inventory of images each depicting a piece of artwork. An electronic virtual queue is provided for retaining selected artwork images chosen from the digital inventory wherein at least one artwork image is selected from the queue which is designated to be virtually positioned and superimposed in the digital image of an area to be decorated.

### CROSS REFERENCE TO RELATED APPLICATIONS

This application claims priority to U.S. Patent Application Ser. No. 61/427,514 filed Dec. 28, 2011 which is incorporated herein by reference in its entirety.

### FIELD OF THE INVENTION

The present invention relates to a system and process which interactively and virtually decorates a room or area, and more specifically to process and system for previewing, positioning and purchasing artwork and other items to be hung, placed or positioned in a room or area.

### BACKGROUND OF THE INVENTION

The selection and placement of art, decorations, shelves, sconces, or other objects on or about a wall or area to be decorated is a highly subjective task that depends upon numerous factors. Some of these factors include the size of the area to be decorated and the placement, size, colors and style of objects adjacent to or already placed on the wall to be decorated, such as windows, doors, window coverings, furnishings and light fixtures. Often, it is a combination of many, or all, of these factors, filtered through the subjective eyes of a decision maker, that determines what piece(s) of artwork are placed in an area to be decorated.

People commonly choose artwork based upon their own tastes, or receive assistance and advice from others in choosing artwork. However, the selection of artwork is influenced by many factors beyond choosing an artist or style. For example, the lighting in the room, the surrounding colors of the walls, ceilings, flooring, the type of window coverings, the style of furnishings and other objects in the room and other factors will influence the appearance of the artwork once it is placed. Most artwork is selected in an environment, such as a gallery, that is unlike the wall and room upon which it will be ultimately placed. These environments tend to be sterile, with the focus on the artwork uninfluenced by other environmental factors that are typical of a residence, office, commercial, or industrial location that is to be decorated.

Thus, the selection of artwork traditionally has been on a “hit or miss” approach. Artwork is selected, placed upon a wall and then returned if its size and/or style does not have the desired impression. This can become a time-extensive and often frustrating project when several pieces are tried. Such a process may also become relatively expensive in the event that artwork has to be shipped or otherwise picked up and/or delivered to the location and back to the source. Many art galleries are located in tourist destinations or other locations remote to the location the purchaser will actually hang the artwork, further exacerbating this problem. The inability for the potential purchaser of artwork to determine whether a selected piece of artwork will fit or look desirable once hung on a wall within the potential purchaser's home, office or other space is a significant impediment to selecting and purchasing artwork.

Another problem with the selection of the artwork is the relative inability to access a broad selection of pieces of artwork. Presently, a significant amount of artwork is purchased through galleries or shops. Thus, in order for an individual to view various pieces of artwork, a personal visit to each of the galleries having the artwork is generally required. This simply is not feasible due to time and travel constraints, so the amount of artwork that is available to a typical individual is limited to the artwork that is available in the areas that the individual resides or happens to be traveling. While it is possible to view books of art to see additional artwork, or even visit websites of available artwork, the artwork available through these avenues is limited and they do not lend themselves to visually inspecting the artwork in a desired environment.

Similarly, shops and/or galleries that provide artwork generally have clientele that is limited to local area residents and visitors to the area that happen to stop at the shop or gallery. However, even if a visitor to the area stops at the shop or gallery, they are often hesitant to purchase a piece due to the considerations described above. Thus, shops or galleries that sell pieces of artwork often have a market that is much smaller than the total market of potential buyers of such pieces of artwork. Individual artists have similarly limited access to potential purchasers of their artwork. Their clientele is generally limited to those who are aware of the artist and her work or has access to and knowledge of the artist's work through galleries, shops or internet sites that feature her art.

As a result, significant inefficiencies exist in pairing suitable artwork, on the one hand, with individuals who are seeking artwork, suitable for a particular location or otherwise, on the other hand.

### SUMMARY OF THE INVENTION

An aspect of the present invention relates to computer system and method for providing virtual decoration of an area to be decorated with artwork. The method and system being adapted and configured to receive a digital image of an area to be decorated and provide a digital inventory of images each depicting a piece of artwork. An electronic virtual queue is provided for retaining selected artwork images chosen from the digital inventory wherein at least one artwork image is selected from the queue which is designated to be virtually positioned and superimposed in the digital image of an area to be decorated.

It is to be appreciated the present invention provides tools and functions which enables the viewing of large quantities of electronic images of Artwork quickly and in a searchable format. The present invention enables: images to be saved in private project files; placement of reserves on Artwork; notification when reserves are coming due; several designers (users) to be placed in a queue for a particular Artwork; images to be virtually positioned into a photograph of a room, space or outdoor landscape; the printing of a cut sheet for a meeting, corresponding directly with Clients from a project file; providing Clients with limited access to search and save to their own project; the provision of an interactive area for the Trade and Clients to come together and view artwork.

In is to be further appreciated and understood, the present invention provides the following features in accordance with an illustrated embodiment.

A “Trade Registration and Login” module providing site-generated email confirming registration, username and password. Any Firm information is collected and stored in a “my profile” file. A Firm has the ability to edit their information and change password.

A “Trade Accounts” module providing the Trade the ability to log into their work in at least the following areas:
“My projects” to create project files; create specific rooms within the project; virtually place Artwork in situ; email Artwork images and virtual placements; provide Client Access.
“My reserves” to: view all reserves for all projects; sort reserves by project, artist, reserve time, expiration; and date, primary reservist status, re-reserve and release reserve.
“My purchases” to: view all purchases for all projects; sort by project, artist, status, and view/edit purchase details.
“My profile” to edit the profile of a user

An “Artwork Database” module which is searchable by Artist, genre, medium (paintings, works on paper, mixed media, installation, photography, sculpture), pallet, dimension range, complete title or keyword in the title. Each Artwork is uniquely identified/tagged. Artwork that meets the combined criteria will populate. It is to be appreciated that by clicking an Artwork image, an “Artwork Detail Page” is provided which preferably contains related information about the Artwork: artist name, title, year, medium, actual medium detail, dimensions, list price. Functions from each Artwork Detail Page are:

An “Image Cropping” module in which all images posted by the Artist are auto cropped for presentation. For sculpture, a tightly cropped image is included for virtual placement.

A “Magnification” module functional to magnify Artwork, preferably via mouse movement, to view finer details of Artwork.

A “Content Management” module, which is preferably adapted and configured for internal administrative use, is functional to update, edit, add and delete content from the website, including adding and deleting search criteria and categories. Page editing is included to manage text on each page of the site. A user may also select Artwork or Artwork images to make public in a Public Area, or private in a Trade area. It is to be appreciated Artists post their own images in “my work” and select the corresponding dropdown boxes to add the details of the Artwork. Relevant notes particular the to Artwork may be entered in a “notes” section. All Artist entries are preferably held before posting, allowing an Artist to edit Artwork prior to the Trade's ability to view. The Artist manages their Artwork inventory in their “my work” area. The site further allows the artist to sort their Artwork by: name, category, sub-category, actual medium, genre, date created, dimension, price. All Artwork may be viewed by an Artist in spreadsheet format, allowing them to view all Artwork posted in an organized manner. The site preferably indicates, with highlight, all Artwork on reserve, sold or archived Artwork.

A “My Projects” module functional to allow the Trade to save and organize Artwork images into private project files. Saved images are initially stored to the selected project in an unassigned area. The Trade may create rooms, drag and drop the unassigned images to a room, reorder the images in a room, or move them out of the room into another room. The entire room and it's contents may be dragged and reordered.

A “My Reserve” module functional to enable the Trade to place a reserve on any Artwork for a predetermined amount of time. For instance, a red “on reserve” will appear under the image and notify other viewers that a particular Artwork is on “reserve”. The first reservist will receive a reserve summary email confirmation. The site will generate a reserve expiration reminder email in 12 days, and a final email that the reserve will expire. Each email has a link directed to the Artwork Detail Page to re-reserve or purchase. The email will also indicate if there is another party in the queue and the Artwork needs to be purchased or the reserve will go the next reservist. The Trade may preferably sort all of their reserves by date of expiration in “my reserves”.

An “Artwork Queue” module functional such that when multiple viewers are interested in the same painting, a queue is formed. An email will preferably auto-generate to the next reservist when the previous reservists' reserve will expire indicating they are next in the queue. The reservist next in the queue is also emailed if the Artwork is sold to the previous reservist. If the Artwork is still available, the link in the email will bring the next reservist to the Artwork detail page and they may place their reserve or purchase.

A “Third Party Integration” module functional to enable Artwork images and all corresponding detail information (client/project name, firm name, artist, title, year, description of Artwork, cost) to be pushed to third party software, such as Studio Webware, whereby proposals, invoicing and payment are generated. It is also functional to push Artwork images and corresponding detail to other partnering sites.

A “My Purchase” module functional whereby sold Artwork is marked “sold” and will remain in job files and on the site for a predetermined time (e.g., 30 days) and is then preferably archived or deleted. The Trade may sort all of their purchases by project, purchase date, in “my purchase”.

A “Projects Share/Email” module functional to enable the Trade to view a summary of all Artwork images and virtual placements saved by room. Preferably mousing over the Artwork title or virtual placement will pop up an image as a reminder. For instance, by clicking a box, the Trade selects what they want to email to clients or colleagues. The email contains each image and all corresponding detail information, including list price.

A “Virtual Placement” module functional to allow the Trade to upload digital images of interiors, outdoor landscapes or CAD elevations for the purposes of virtual placement of Artwork, installation or sculpture in situ. One or many saved Artwork images can be added to uploaded background images and dragged into position and scaled. A saved Virtual Placement may be re-opened and edited and saved again. Background images are stored and used for other virtual placements. Virtual placement provides the Trade and their clients with greater confidence that the right Artwork is selected for the space. It is a virtual “try it in the room”. All virtual placements may be emailed directly from the project file.

An “Interactive Client Access” module functional to enable the trade to provide their client(s) with a username and password to provide limited access to their project. Preferably, an email is auto-generated to the Client and Trade with Client login information. Client may view their project and saved images, view all of the Artwork and Artists, search and save to their own project. The Trade's Client access information is stored in the project file. A Client may indicate they “like” Artwork by clicking on an icon such as a thumbs up “like” icon. The Trade may view Artwork the Client has saved to the project file and view what the Client “likes”. Clients and the Trade may both be logged into their account at the same time for purposes of an on-line meeting.

### BRIEF DESCRIPTION OF THE DRAWINGS

The objects and features of the invention can be understood with reference to the following detailed description of an illustrative embodiment of the present invention taken together in conjunction with the accompanying drawings in which:

FIG. 1 depicts an illustrative computer environment for the present invention;

FIG. 2 is an illustration of a portion of an area to be decorated in accordance with the present invention;

FIG. 3 is a block system level diagram depicting software modules implemented with the computer environment of FIG. 1 in accordance with illustrative embodiments of the present invention; and

FIGS. 4 to 13 depict various illustrative embodiments of the present invention implemented on a website.

### WRITTEN DESCRIPTION OF CERTAIN EMBODIMENTS OF THE INVENTION

The present invention is now described more fully with reference to the accompanying drawings, in which an illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

It is to be appreciated the embodiments of this invention as discussed below are preferably a software algorithm, program or code residing on computer usable medium having control logic for enabling execution on a machine having a computer processor. The machine typically includes memory storage configured to provide output from execution of the computer algorithm or program.

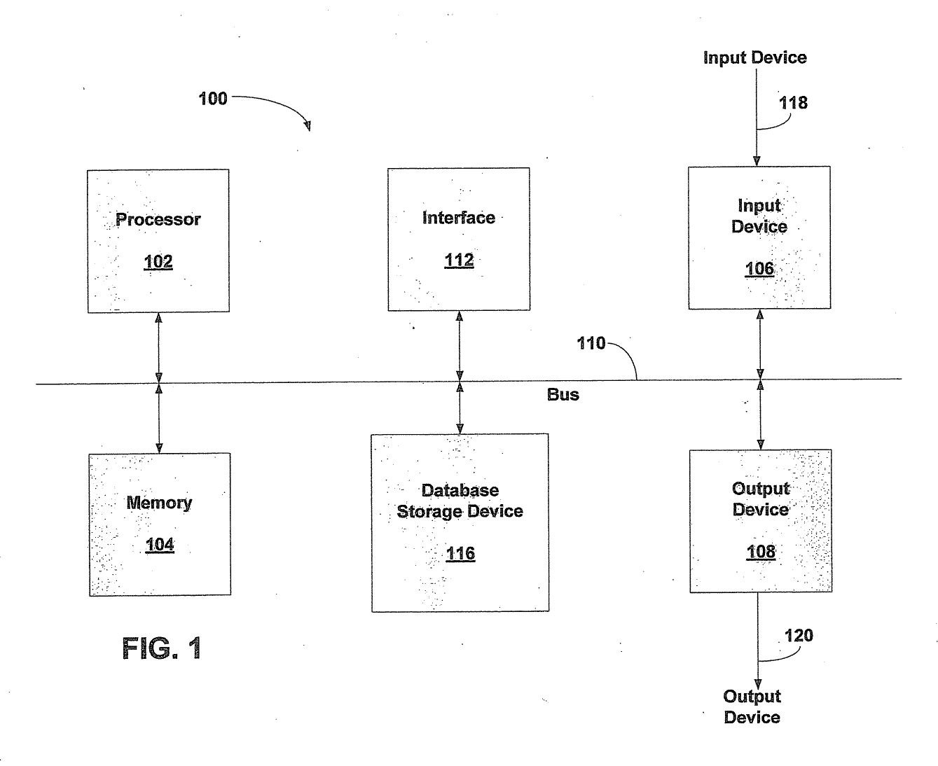

Turning now descriptively to the drawings, in which similar reference characters denote similar elements throughout the several views, FIG. 1 depicts an exemplary general-purpose computing system in which illustrated embodiments of the present invention may be implemented.

A generalized computering embodiment in which the present invention can be realized is depicted in FIG. 1 illustrating a processing system 100 which generally comprises at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could comprise more than one distinct processing device, for example to handle different functions within the processing system 100. Input device 106 receives input data 118 and can comprise, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can comprise, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, at least one database 116. The interface 112 may allow wired and/or wireless communication between the processing unit 102 and peripheral components that may serve a specialized purpose. Preferably, the processor 102 receives instructions as input data 118 via input device 106 and can display processed results or other output to a user by utilizing output device 108. More than one input device 106 and/or output device 108 can be provided. It should be appreciated that the processing system 100 may be any form of terminal, server, specialized hardware, or the like.

It is to be appreciated that the processing system 100 may be a part of a networked communications system. Processing system 100 could connect to a network, for example the Internet or a WAN. Input data 118 and output data 120 could be communicated to other devices via the network. The transfer of information and/or data over the network can be achieved using wired communications means or wireless communications means. A server can facilitate the transfer of data between the network and one or more databases. A server and one or more databases provide an example of an information source.

Thus, the processing computing system environment 100 illustrated in FIG. 1 may operate in a networked environment using logical connections to one or more remote computers. The remote computer may be a personal computer, a server, a router, a network PC, a peer device, or other common network node, and typically includes many or all of the elements described above.

It is to be further appreciated that the logical connections depicted in FIG. 1 include a local area network (LAN) and a wide area network (WAN), but may also include other networks such as a personal area network (PAN). Such networking environments are commonplace in offices, enterprise-wide computer networks, intranets, and the Internet. For instance, when used in a LAN networking environment, the computing system environment 100 is connected to the LAN through a network interface or adapter. When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the computing system environment 100, or portions thereof, may be stored in a remote memory storage device. It is to be appreciated that the illustrated network connections of FIG. 1 are exemplary and other means of establishing a communications link between multiple computers may be used.

FIG. 1 is intended to provide a brief, general description of an illustrative and/or suitable exemplary environment in which embodiments of the below described present invention may be implemented. FIG. 1 is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing system environment 100 of FIG. 1. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, multiprocessor systems, microprocessor-based systems, set top boxes, programmable consumer electronics, network, minicomputers, server computers, game server computers, web server computers, mainframe computers, tablet devices, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

With the exemplary computing system environment 100 of FIG. 1 being generally shown and discussed above, the present invention, in accordance with illustrated embodiments provides a system and process for facilitating the decoration of an area or room, and particularly a surface, such as a wall in a room. In one illustrated embodiment, a system is provided that allows a user to view a simulation of the placement of selected artwork on a particular wall. It is to be expressly understood that the illustrated embodiments discussed herein are provided for descriptive purposes and are not meant to limit the scope of the claimed inventions. Other embodiments are considered to be within the inventive scope.

For example, a system of one illustrated embodiment of the invention would assist a user/decorator in decorating a home, workplace, and/or other wall with artwork. This embodiment allows the user to view images of various types of artwork together with an image of the wall that is to be decorated. It is noted that the term “artwork” is given an expansive definition that refers to any items that may be placed on or in proximity to a wall for purposes of decorating a room and/or other area in which decoration is desired. Such items may include, but are not limited to, paintings, prints, photographs, tapestries, rugs, window coverings, drapes, mirrors, candle holders, shelves, sconces, lighting fixtures, clocks, flat panel screens for the display of images, white boards, chalk boards, and/or other objects used to decorate an area, including any frames, matting, and/or displays associated with the items. This helps a user to find artwork that is compatible with the size of the wall area to be decorated and the current décor, for example, of the user's apartment wall. Moreover, other embodiments of the present invention are able to operate over a computer network to allow a user to browse through online art galleries and view a combined image of the wall area to be decorated and one or more artwork pieces. Further embodiments of the present invention allow a user to post or submit wall area images of wall areas to be decorated so that designers, artists, gallery owners and others can access the wall area image and provide suggested artwork images of artwork items for the area to be decorated. Once the artwork is selected, the user may then purchase the artwork if desired. Such a purchase may be made with added confidence that the particular artwork piece that is purchased will be a dimensionally good fit for the wall area to be decorated and produce the aesthetic effect that the user desires.

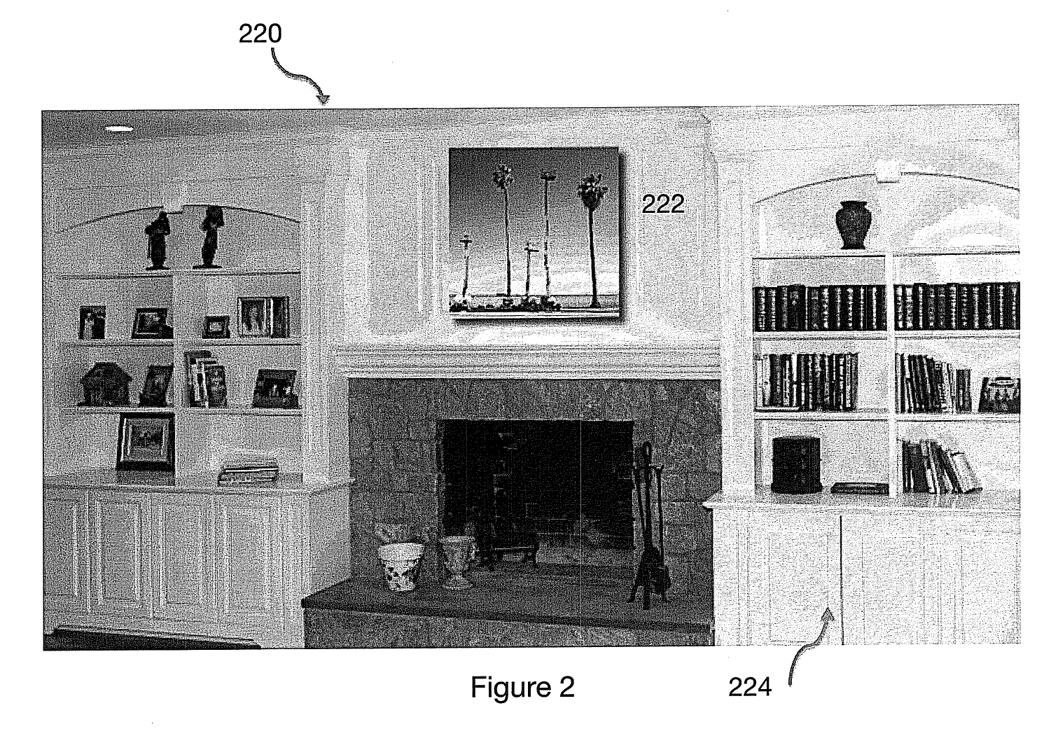

One illustrated embodiment of the present invention is illustrated in FIG. 2. The user, in this example, desires to decorate wall 222 in a room 220, partially illustrated in FIG. 2. The room 220 may be a location in a home, business, or any other location where decoration is desired. Moreover, the room 220 may be an indoor space, an outdoor space, or a combination of an indoor and outdoor space. The room 220 typically includes a number of elements that contribute to the décor or interior design of the room 220. For example, the walls of room 220 may be painted, textured, wallpapered, and/or stenciled. Different colors and motifs may be utilized to set a mood for the room 220. In addition, furniture 224 of a particular style, color, or other visual features may help establish the area's décor. The room 220 may also contain windows, doors, fireplaces, and/or other fixtures that influence the area décor. Furthermore, floor rugs, existing artwork, and existing window coverings may also influence the area's décor. Also, lighting from artificial and/or natural light sources may play an important factor in the selection of artwork. Although highly subjective, a user purchasing artwork often attempts to complement a room's décor with the artwork. Thus, as discussed in more detail below, various embodiments of the present invention help the user select artwork that is of the desired size for the area and that is compatible with the room's existing décor according to the user's individual tastes and preferences.

It is to be appreciated that an aspect of the invention is preferably directed to wholesale and web based businesses representing a collective of emerging, mid career and established fine Artists and images of their works of art (Artworks) and is an Artworks resource for architects and interior designers (the Trade). The invention preferably provides the Trade with a plurality of electronic images of Artworks, functionality and tools so that Trade may view, search, save, organize by room, virtually place to scale, and/or share their final selections with their clients.

The illustrative embodiments of the invention encompasses several elements all of which, together, preferably provide a unique virtual gallery, resource, functionality, tools and work area for the Trade and their clients. A unique aspect of the invention is it preferably does not conflict with the Artist's gallery representation, solo or group exhibitions or published work because system and process of the present invention is structured as a virtual gallery and is intended only for the Trade (e.g., architects and interior designers). Preferably the present invention system and process does not sell Artworks directly to the public (although the Trade may give their clients access to view Artworks).

It is to be appreciated and understood the invention in accordance with illustrative embodiments provides a platform for the Trade for adding Artworks to their projects in an efficient manner, saving them time, effort and money to travel to individual galleries to source Art. The present invention provides an electronic inventory of Artworks and has incorporated tools and functions that serve as a virtual work environment for the Trade. In particular, some of the advantages of providing a virtual inventory of Artworks in accordance with illustrated embodiments of the invention is it enables the Trade to:
quickly view a large volume of Artworks by Artist or by a specific search
specific search criteria is by genre, medium, artist, dimension, palette
view a detail page of each Artwork
log into the system as a company/firm and have create private company job files
save images to a job file.
within the job file, create specific rooms, drag and drop unassigned images to a room, or edit and move the image to another room
reserve an Artwork or be placed in a queue
enable the Trade to upload images of a room/area or CAD drawings of elevations thereof and virtually place selected Artworks in the space to scale
enable the trade to select images to email to their clients, as individual images or virtually placed images
push an image to a studio designer software program to create proposals

Thus, it is to be appreciated the present invention provides the Trade with the ability to: view a plurality (e.g., thousands) of electronic images of Artworks quickly, search by many different categories (list attached), store the images of their selections in private job files, put reserves on Artworks, be notified when reserves are coming due, allow several designers to be placed in a queue for a particular Artworks, virtually place images into a photograph of the room, space or outdoor landscape and share with their clients—all to select the right Artworks for the right space, prior to shipping Artworks.

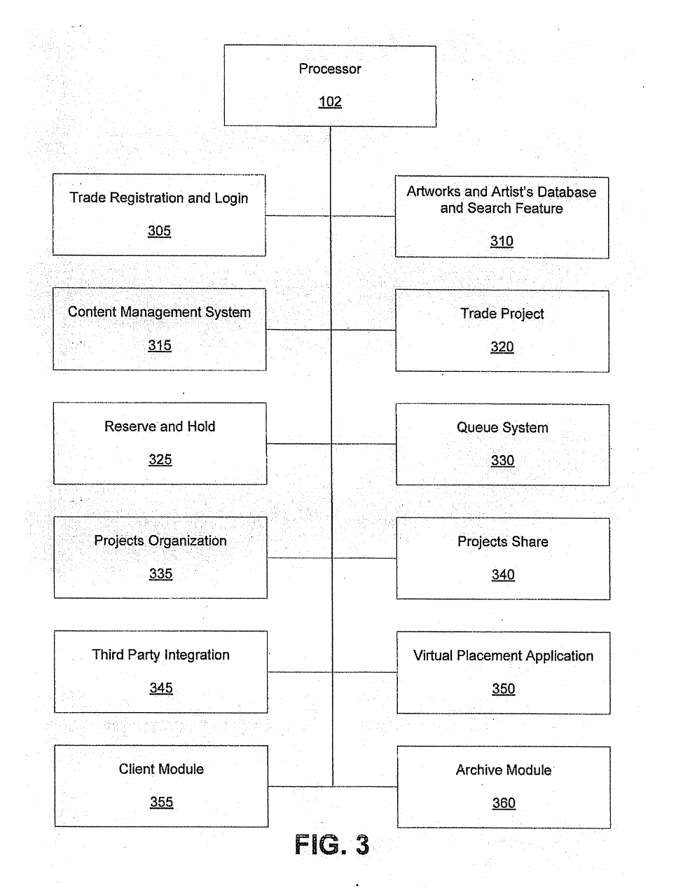

With reference now to FIG. 3, certain software modules of the system 100 are illustrated which each preferably instructs processor 102 of system 100 to perform intended below discussed functions in accordance with illustrated embodiments of the present invention.

The Trade Registration and Login module 305 enables Trade firms (the Firm) to access system 100 and be provided with a user name and password. For instance, to do so, a Firm may fax their resale certificate to system 100 wherein company information is collected and stored. When the firm has been approved for access, an automatic email will be generated with their firm's user name and password. The Artworks and Artist's Database and Search Feature module 310 provides and enables an Artworks database that is searchable by Artist, genre, medium (paintings, works on paper, photography, sculpture), pallet, dimension range, and by complete title or any keyword in the title) wherein preferably, each Artwork is tagged (FIG. 3). The Trade can create a custom search and those Artworks that meet the criteria and images will be identified and indicated. Sold Artworks are preferably marked sold and will remain in job files and on the site, and removed after the predetermined period of time, such as thirty days. New Artist's Artworks are preferably continually posted to the electronic image inventory. The Content Management System 315 modules provides the ability to update, edit, add and delete content from a web portal or website which includes scaling tools providing the functionality to shrink or enlarge an Artwork so as to scale it to a room/area it is to be virtually applied to and a magnification tool which enlarges a selected portion of the Artwork enabling detailed inspection of the Artwork. Additionally, page editing is included to manage text on each page of the site. It is to be appreciated Artists can create their own accounts and manage the posting of their images, which the system 100 manages. A Trade Project module 320 is configured to enable the Trade to save Artworks images into electronic job files, preferably by client sidemark wherein the images are initially stored to one file. The Trade may create rooms and drag and drop the unassigned images to a room, reorder the images in a room, or move them out of the room into another room. The Trade may also drag and reorganize the entire order of the rooms. The Artworks “Reserve” and “Hold” module 325 is configured to enable the Trade to save desired and selected images to the aforementioned electronic files but preferably will only be able to do so for a predetermined period of time, such as a seven business day “reserve” with preferably a limit of a predetermined amount of Artworks, such as ten Artworks per Artist at one time. In the general image inventory, once an Artworks has been put on hold, a red “on reserve” flag will appear and notify other people searching that a particular Artworks is on “reserve”. Near the end of the “reserve” an automatic email will be generated alerting the firm that the hold is about to expire. The first firm that has reserved an Artworks may extend the “reserve” an additional predetermined amount of time, such as seven days. After expiration of the predetermined amount of time, the next person in the queue (described below) may reserve.

The Queue System module 330 is configured to provide functionality wherein if multiple firms/persons are interested in the same Artwork, a queue will form for that Artwork in which the firm or entity that is first in the queue (i.e., has virtual possession of the Artwork) will have temporary possession of the Artwork for a predetermined period of time (e.g., seven days) during which they may purchase the Artwork. After expiration of the predetermined amount of time, virtual possession of the Artwork then goes to the next person/firm in the queue. An email will automatically be generated to the interested firm stating when the hold will expire, and that they are next in the queue. The Projects Organization system module 335 provides functionality to system 100 such that a Trade client may create project files and save images to the individual projects they are working on, as they search. Once the images have been saved to the general inventory for a particular project (e.g., the “Jones project”), the designer can create room names and drag unassigned images to the rooms they are being considered for. They can be dragged out of rooms and into others and the rooms themselves may be dragged and organized within the project file to organize by room priority. The Projects Share module 340 provides functionality to system 100 enabling selected images in the “projects” system 335 to be shared with the firm's various clients. The Third Party Integration module 345 provides third party integration functionality enabling images to be pushed to various software programs utilized by the Trade (e.g., Studio Designer), preferably for the purpose of including the images of the Artworks into proposals unique to a third party software program (e.g., Studio Designer). For instance, Studio Designer is a software program that creates an infrastructure for the Trade to run their businesses financially, to generate invoices, inventory tracking and to generate proposals with product images. In addition to images pushed to Studio Designer, Third Party Integration module 345 enables images of Artworks to be pushed and integrated with other third party software, such as ShopAD and Decorati.

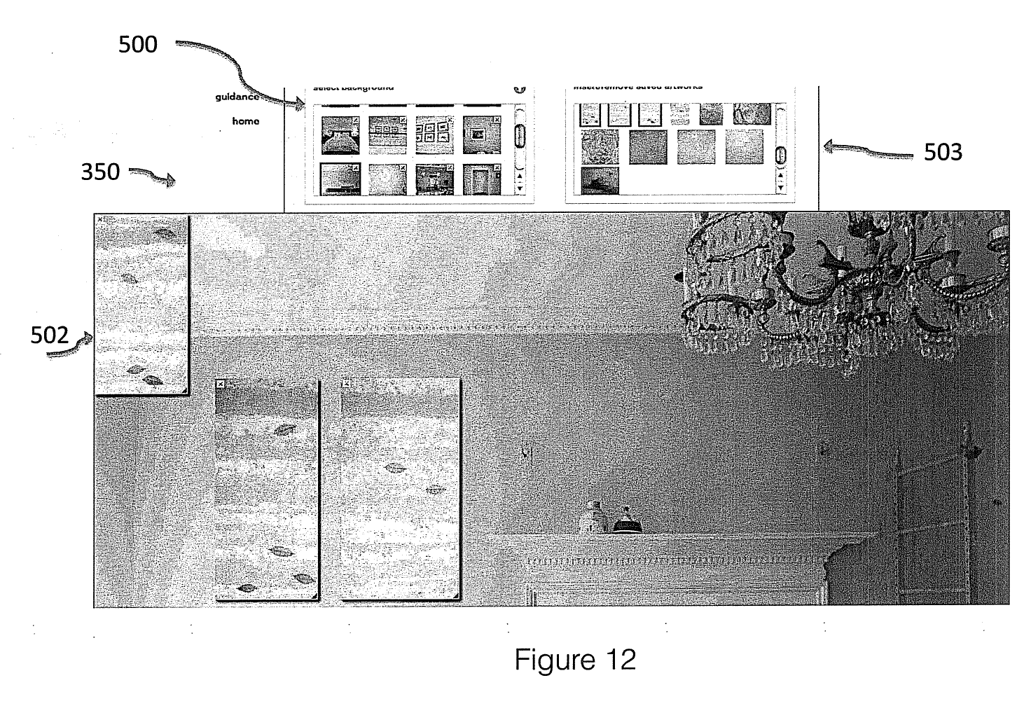

The Virtual Placement Application module 350 enables virtually placement of Artwork in a room/area uploaded by the Trade to be decorated. Virtual placement enables the Trade to upload photographs of interior rooms and outdoor landscapes, areas or CAD drawings for the purposes of virtual placement of Artworks or sculpture in situ. The virtual placement tool will position the Artworks in the “project” and position those Artworks on the wall scaling it to size in the process. This allows the client greater confidence in the decision to purchase and that they are selecting the right Artworks for the right space. It is a virtual “try it in the room”. For instance, and with reference to FIG. 12, shown is virtual placement module 350, wherein a user can select a user uploaded area to be decorated background 500 to appear in a user work area 502 wherein a user also selects artworks saved to their virtual queue 503 which are superimposed in the aforesaid user selected uploaded area to be decorated background 500, via the user work area 502.

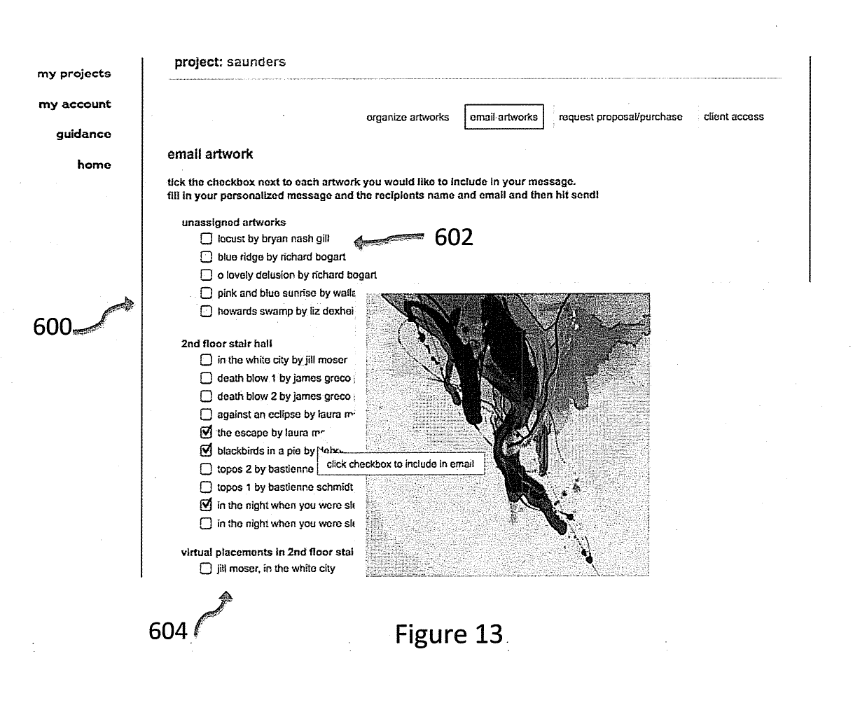

It is to be appreciated the Virtual Placement Application module 350 preferably also includes a magnification tool which enlarges a selected portion of a selected Artwork enabling detailed inspection of the Artwork. A Client module 355 enables public preview (no registration necessary) of a predetermined number (e.g., twenty) of Artworks from each Artist for the purpose of involving the clients of the Trade, to choose Artists they respond to. If they like a particular Artwork, they may email it to their interior designer from the public preview area. For instance, and with reference to FIG. 13, shown is an email module 600 in which a user can email images of artworks, both assigned to an area to be decorated 602, and not assigned 604 to any area to be decorated.

Preferably provided is a preview virtual gallery providing a platform for collaboration between the client and their interior designer or architect. An Archive module 360 archives various data and information such as press, portfolio of projects, favorites and buzz marketing communications, and sold Artworks so they may be referenced for future commissions.

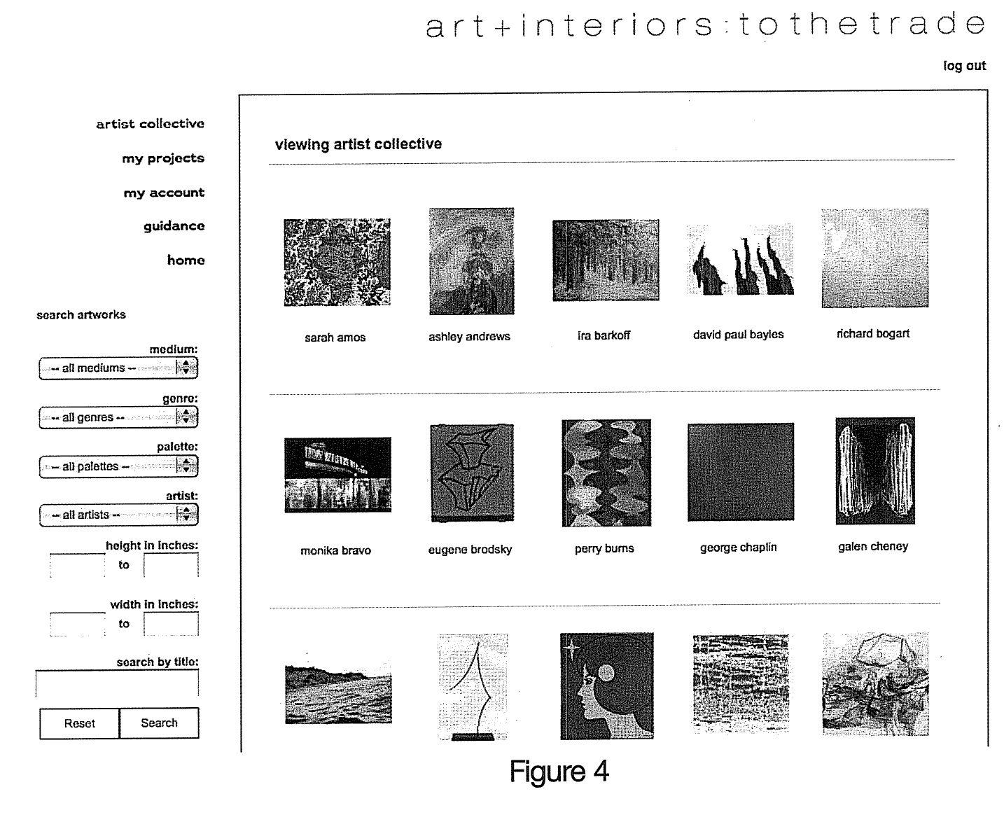

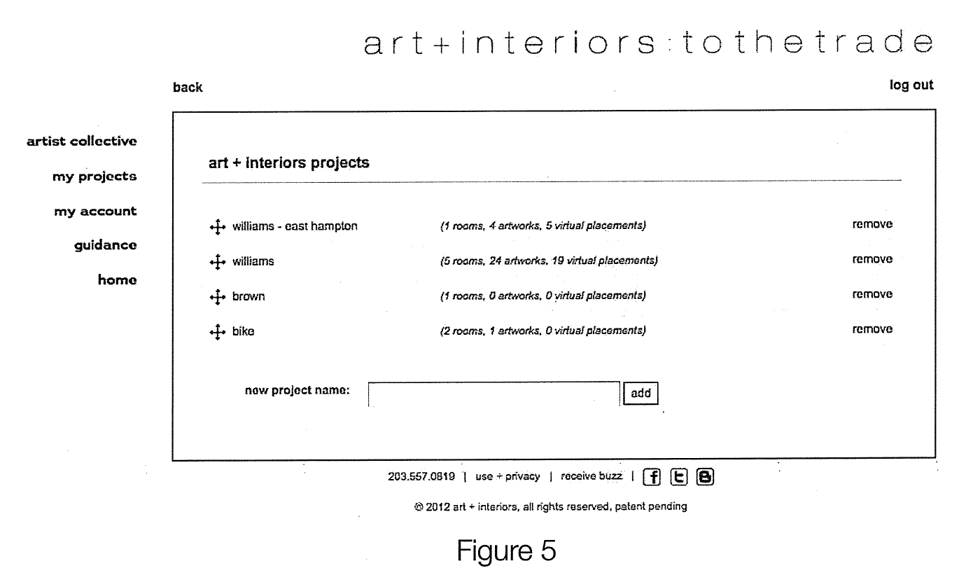

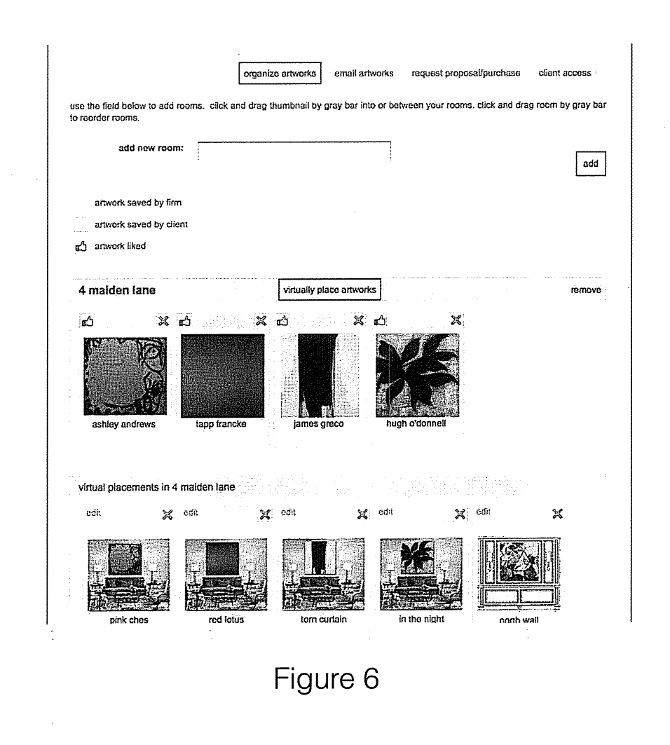

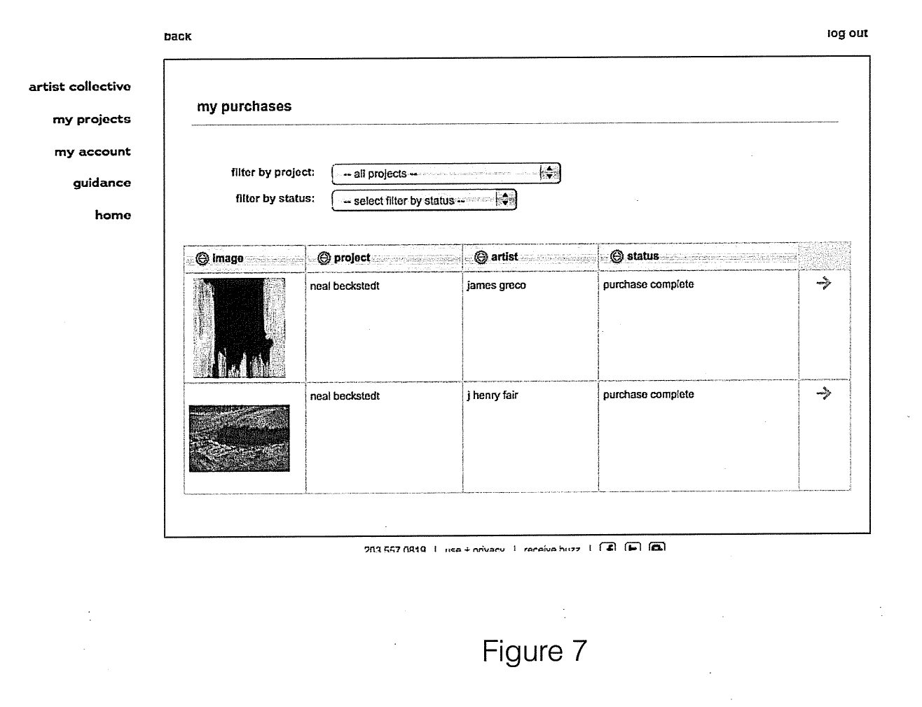

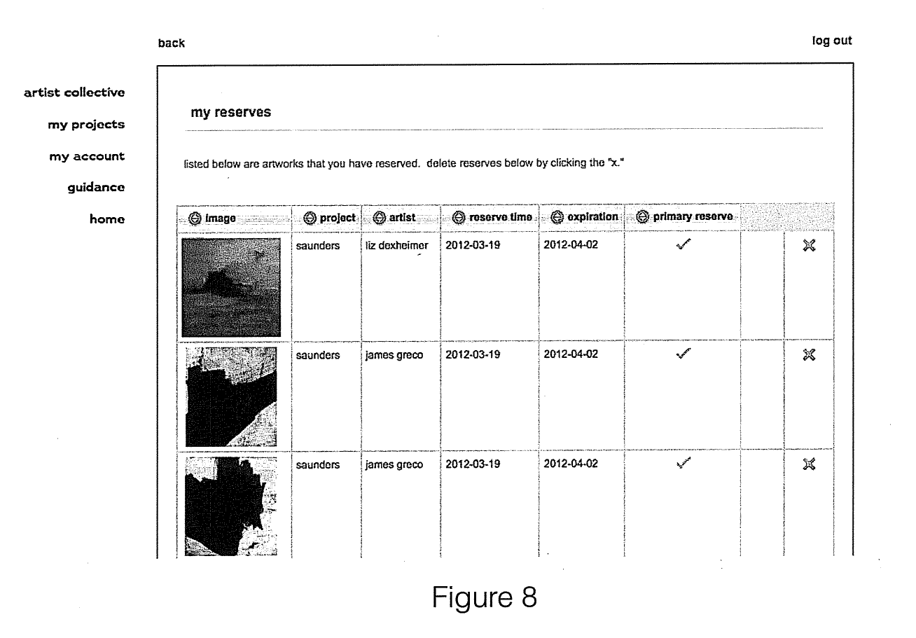

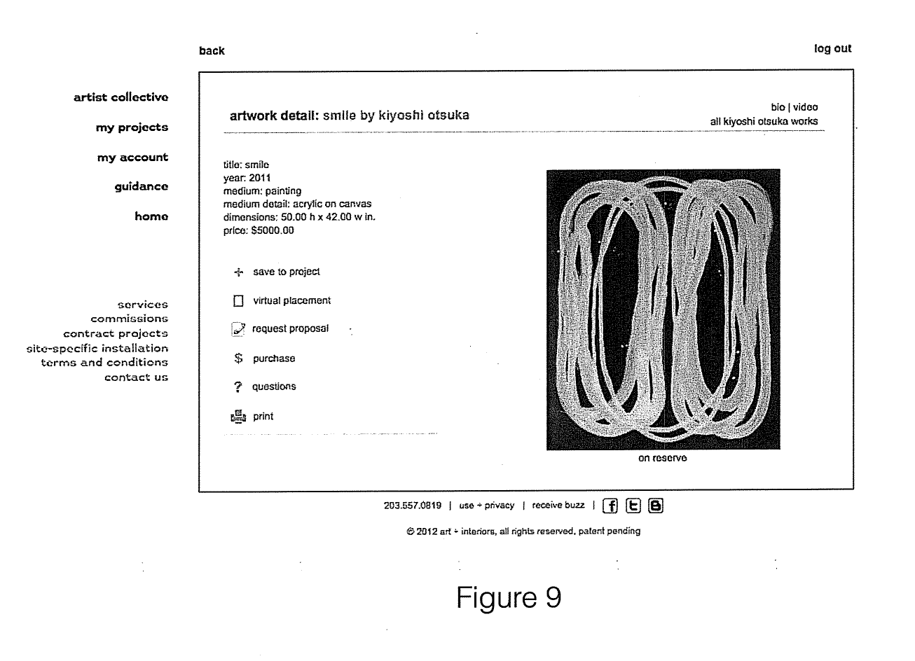

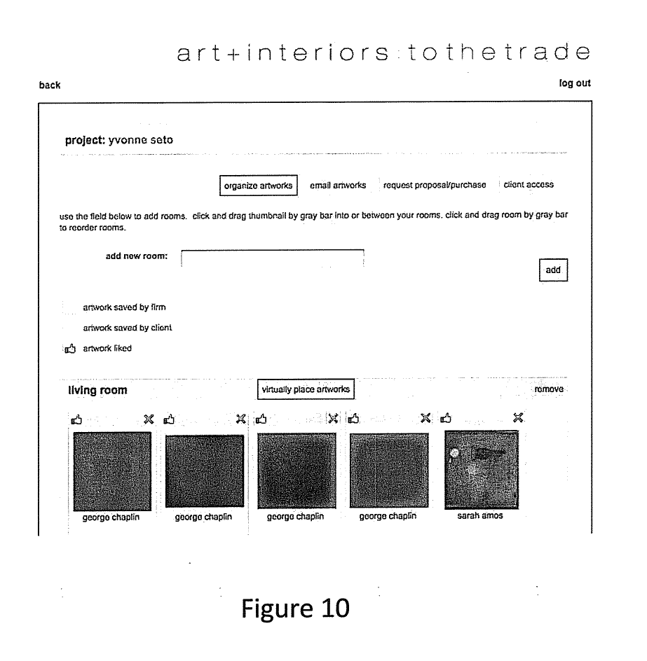

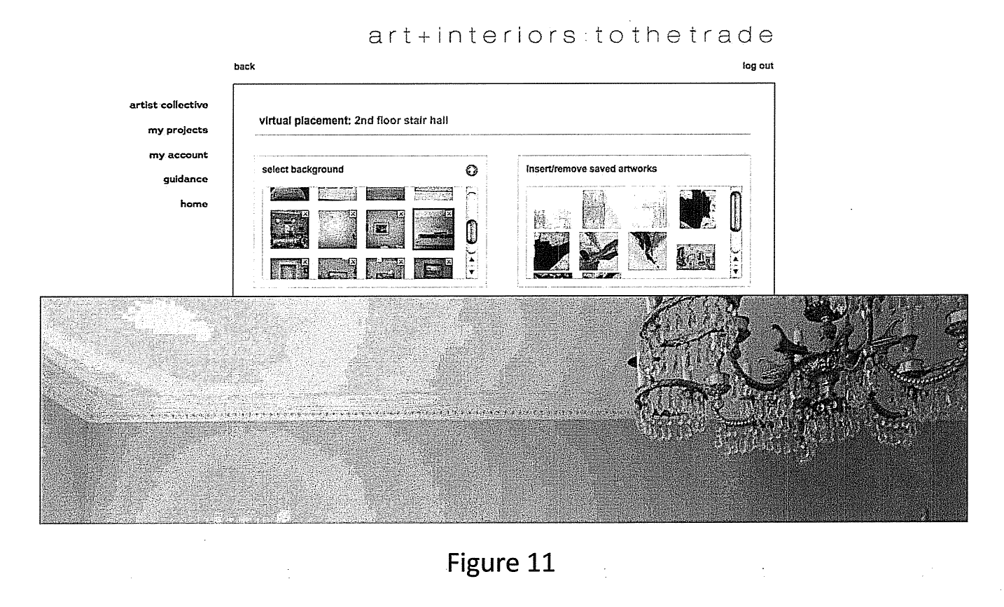

With reference now to FIGS. 4 to 11, shown are various images of illustrative embodiments of the invention embodied in a website and incorporating the above described functionality which is to be considered part of this description of the present invention in accordance with the illustrated embodiments. It is to be understood and appreciated that advantages of the present invention in accordance with the illustrated embodiments include the assembly of various Artists for the Trade, which is akin to gathering a large number (e.g., twenty) of traditional galleries together under one virtual roof. Additionally, and as mentioned above, technical tools and functions (via software modules) are provided enabling the Trade to work in the internet environment, using an internet portal to view, search, select, save to a job, organize images within a job, reserve, placement in a queue, and virtually place and share images of Artworks with their clients by job and by room. The virtual gallery provided by the present invention provides a process for the Trade to search for Artworks which saves time, money and effort for the Trade. It is to be understood and appreciated, a unique attribute of the present invention is the combination of providing a virtual gallery, tools and functions for the Trade to work on their projects and providing a forum for collaboration between the Trade and their clients.

Having generally described various aspects of the invention, a specific implementation of an embodiment is discussed below. It is to be expressly understood that this embodiment is provided for descriptive purposes only and is not meant to limit the scope of the claimed inventions. Other physical implementations are available as well under the claimed inventions.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention has been described, it should be understood that various changes, substitutions, and alterations can be made by one of ordinary skill in the art without departing from the scope of the present invention.

1. A computer implemented method for providing virtual decoration of an area to be decorated with artwork, the method comprising the steps of:
receiving a digital image of an area to be decorated;
providing a digital inventory of images each depicting a piece of artwork;
providing an electronic virtual queue adapted and configured to retain selected artwork images chosen from the digital inventory;
selecting at least one artwork image from the queue which is designated to be virtually positioned in the digital image of an area to be decorated;
positioning and displaying the selected at least one artwork from the queue in the digital image of an area to be decorated.

2. A computer implemented method of claim 2, wherein the positioning and displaying step includes placing said selected artwork image proximate said digital image of an area to be decorated.

3. A computer implemented method of claim 2, wherein the positioning and displaying step includes overlapping said selected artwork image onto said digital image of an area to be decorated.

4. A computer implemented method of claim 1, wherein the step of receiving a digital image includes receiving multiple digital images each corresponding to a separate area to be decorated.

5. A computer implemented method of claim 1, wherein said digital image is a photograph.

6. A computer implemented method of claim wherein said digital inventory of images is user searchable by predefined search criteria.

7. A computer implemented method of claim 6, wherein the selecting at least one artwork step includes receiving a search request from a user identifying one or more search criteria; applying said search criteria to a set of artwork images to identify a subset of artwork images that meet said search criteria; and providing said subset of artwork images.

8. A computer implemented method of claim 6, wherein said search criteria include at least one of an artwork dimension, an artwork color, an artwork decorative category, an artwork cost, an artwork medium and artist name.

9. A computer implemented method of claim 6, wherein each inventoried artwork image is associated with a separate description of said artwork image.

10. A computer implemented method of claim 1, further including the step of defining separate electronic job files for a user whereby said user can associate selected artwork images with a said job file.

11. A computer implemented method of claim 10, further including the step of defining separate areas to be decorated in each said job file whereby a user drags and drops selected artwork images to each area to be decorated.

12. A computer implemented method of claim 1, wherein the step of providing an electronic virtual queue includes reserving a said selected artwork image placed in said queue by a user so as not to be purchased by other users.

13. A computer implemented method of claim 12, wherein the step of providing an electronic virtual queue includes defining conditions for a time period for which a selected artwork image may be reserved by a user.

14. A computer implemented method of claim 1, further including the step of providing means to a user for sending an image of an area to be decorated having a superimposed image of a selected artwork to a client of said user.

15. A computer program product comprising a computer usable medium having control logic stored therein for causing a computer to virtually decorate an area to be decorated with artwork, said control logic comprising:
first computer readable program code means for causing the computer to receive a digital image of an area to be decorated and providing
a digital inventory of images each depicting a piece of artwork; and
an electronic virtual queue adapted and configured to retain selected artwork ages chosen from the digital inventory;
second computer readable program code means for causing the computer to select at least one artwork image from the queue which is designated to be virtually positioned in the digital image of an area to be decorated and position and display the selected at least one artwork from the queue in the digital image of an area to be decorated.

16. A computer system for viewing a simulation of at least one artwork image in an area to be decorated, the system comprising:
input and memory means for receiving and storing a digital image of an area to be decorated and for providing a digital inventory of artwork images;
processing and memory means for providing an electronic virtual queue adapted and configured to retain selected artwork images chosen from the digital inventory and for selecting at least one artwork image from the queue which is designated to be virtually positioned in the digital image of an area to be decorated;
processing and display means for positioning and displaying the selected at least one artwork from the queue in the digital image of an area to be decorated.

17. A computer system as recited in claim 16 wherein the processing and memory means are further adapted and configured to define separate electronic job files for a user whereby said user can associate selected artwork images with a sad job file.

18. A computer system as recited in claim 16 wherein the processing and memory means are further adapted and configured to define separate areas to be decorated in each said job the whereby a user drags and drops selected artwork images to each area to be decorated.

19. A computer implemented method of claim 18, wherein the processing and memory means are further adapted and configured to reserve a said selected artwork image placed in said queue by a user so as not to be purchased by other users.

20. A computer implemented method of claim 16, wherein the input and memory means are further adapted and configured to provide user searching of artwork images using predefined search criteria via a user search request identifying one or more search criteria.
